(19) United States
(12) Patent Application Publication
(10) Pub. No.: US 2011/0277546 A1
(43) Pub. Date: Nov. 17, 2011

(54) TANK FULLNESS MONITORING SYSTEM

(76) Inventors: David L. Armitage, Golden, CO (US); Gregory Froim Kushnir, Denver, CO (US); Mark Alvin Mason, Thornton, CO (US)

(21) Appl. No.: 13/105,409

(22) Filed: May 11, 2011

Related U.S. Application Data
(60) Provisional application No. 61/333,464, filed on May 11, 2010.

(51) Int. Cl. G01F 23/44

(52) U.S. Cl. 73/311

(57) ABSTRACT

What is disclosed is a tank fullness monitoring system. The tank fullness monitoring system includes a plurality of buoyant sensor nodes coupled in series along a line, where the buoyant sensor nodes are configured to hang in series along the line, and where each of the buoyant sensor nodes is configured to indicate when floating at a fluid interface. The tank fullness monitoring system also includes a control node attached to the tank and coupled to a first one of the buoyant sensor nodes, and configured to monitor the buoyant sensor nodes.

### RELATED APPLICATIONS

This patent application is related to and claims priority to U.S. Provisional Patent Application No. 61/333,464, entitled “Tank Fullness Monitoring System,” filed on May 11, 2010, which is hereby incorporated by reference in its entirety.

### TECHNICAL FIELD

Aspects of the disclosure are related to the field of electronic sensing devices, and in particular, tank fullness sensing devices.

### TECHNICAL BACKGROUND

Fluid storage tanks are used in a variety of liquid and gas storage systems, such as for storing water, oil, gasoline, chemicals, or other substances. However, measuring a fullness of a fluid storage tank can be difficult. Direct physical measurement, such as via measurement rods or visual inspection, is cumbersome and can be inaccurate or slow. Rigid float-based systems also can measure fluid levels, but deployment into a fluid storage tank present maintenance, mounting, and calibration problems.

### Overview

What is disclosed is a tank fullness monitoring system. The tank fullness monitoring system includes a plurality of buoyant sensor nodes coupled in series along a line, where the buoyant sensor nodes are configured to hang in series along the line, and where each of the buoyant sensor nodes is configured to indicate when floating at a fluid interface. The tank fullness monitoring system also includes a control node attached to the tank and coupled to a first one of the buoyant sensor nodes, and configured to monitor the buoyant sensor nodes.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1A is a system diagram illustrating a tank fullness monitoring system.

FIG. 1B is a system diagram illustrating a tank fullness monitoring system.

FIG. 2A is a system diagram illustrating a tank fullness monitoring system.

FIG. 2B is a system diagram illustrating a tank fullness monitoring system.

FIG. 3 is a block diagram illustrating a control node.

FIG. 4 is a block diagram illustrating a buoyant sensor node.

### DETAILED DESCRIPTION

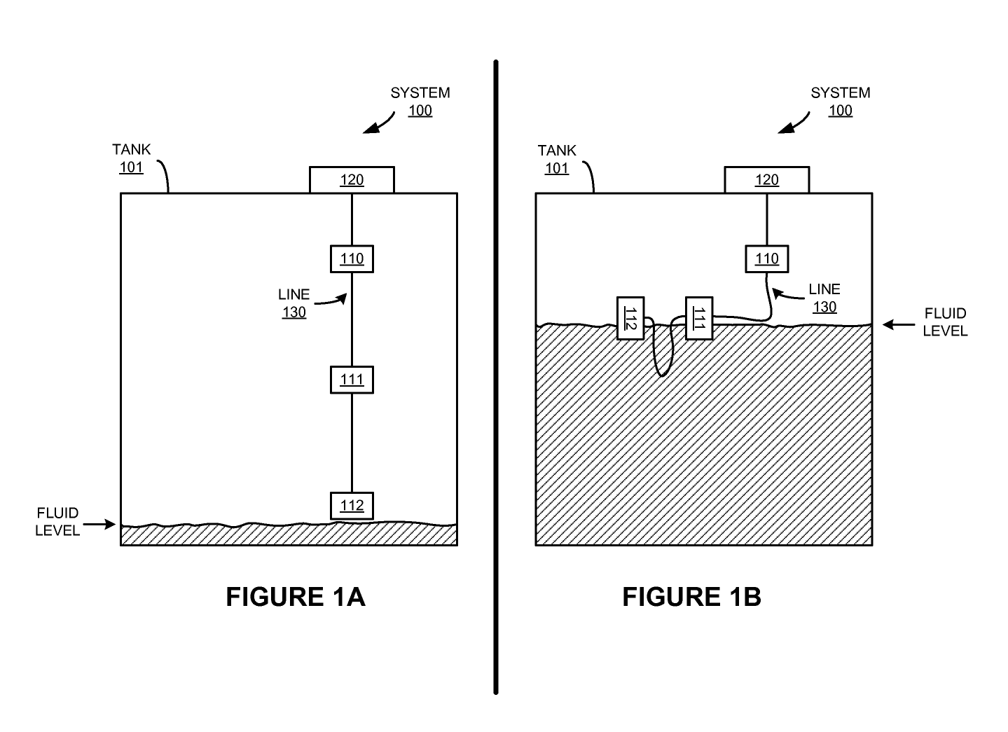

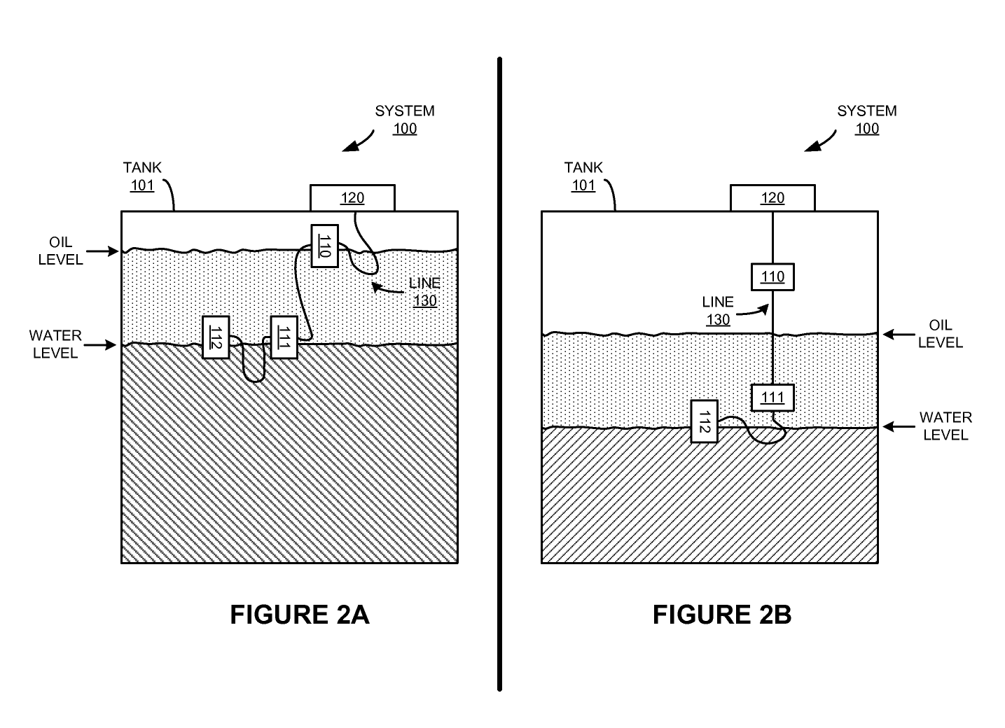

FIGS. 1A-1B and FIGS. 2A-2B are system diagrams illustrating tank fullness monitoring system 100. System 100 includes tank 101, control node 120, buoyant sensor nodes 110-112, and line 130. Control node 120 is attached to tank 101. Control node 120 and each of sensor nodes 110-112 communicate over line 130. Sensor nodes 110-112 also are coupled in series along line 130, with sensor node 110 coupled to control node 120. Tank 101 comprises a vessel or container for fluids. Tank 101 could contain liquid, gas, or particulate contents.

Each of sensor nodes 110-112 is coupled to sensor node 120 in a series fashion along line 130. In this example, each of sensor nodes 110-112 is coupled electrically to control node 120 by line 130. Each of sensor nodes 110-112 includes a sensor portion and a buoyancy system. The sensor portion could comprise a mercury switch, magnetic switch, thermometers, thermocouples, thermopiles, emitters/detectors, microphones, accelerometers, strain gauges, flow gauges, chemical sensors, micro-electromechanical system (MEMS) sensors, electrical sensors, among other sensing equipment and circuitry. The sensor portion could also include a transceiver portion for communication with control node 120. In some examples, the transceiver portion includes a wireline transceiver for communicating over line 130 via a wire, optical fiber, or other medium. In other examples, the transceiver portion includes a wireless transceiver and antenna. Each of sensor nodes 110-112 could also include a processing portion for receiving sensor information, amplifying, scaling, modifying, adjusting, digitizing, or converting the information, as well as for controlling the transceiver portion and sensor portion. Each of sensor nodes 110-112 could also comprise a power system, such as a battery.

Control node 120 comprises equipment for receiving sensor information from each of sensor nodes 110-112. In some examples, the information is received over line 130, while in other examples, the information is received wirelessly from each of sensor nodes 110-112. Control node 120 also includes equipment to attach control node 120 to tank 101 as well as support each of sensor nodes 110-112 along line 130. In some examples, control node 120 is attached to tank 101 with fasteners, such as screws, rivets, while in other examples, control node 120 is attached to tank 101 magnetically or with an adhesive. Control node 120 also includes communication interfaces, as well as a computer system, microprocessor, circuitry, or some other processing device or software system, and may be distributed among multiple processing devices. Examples of control node 120 may also include software such as an operating system, logs, utilities, drivers, networking software, and other software stored on a non-transient computer-readable medium. In some examples, each of sensor nodes 110-112 includes a level-sensitive switch, such as a mercury switch, and control node 120 includes the associated circuitry to drive and monitor the level-sensitive switches of sensor nodes 110-112. Control node 120 could include complementary or additional sensors, equipment, and circuitry as to each of sensor nodes 110-112. In some examples, control node 120 is not employed, and only sensor nodes 110-112 are employed.

In the examples shown in FIGS. 1A and 1B, line 130 comprises a composite cable with a hanging or tensional support, such as wire, cable, rope, cord, or sheathing, along with electrical wires or optical fibers for sensor nodes 110-112. Line 130 could be comprised of several segments which together form the entire line between control node 120 and all of sensor nodes 110-112. Line 130 could use various communication media, such as air, metal, optical fiber, or some other signal propagation path, including combinations thereof. Line 130 could use various communication protocols, such as Internet Protocol (IP), Ethernet, Controller Area Network (CAN) bus, Inter-Integrated Circuit (I2C), 1-Wire, optical, optical networking, circuit-switched, communication signaling, or some other communication format, including combinations, improvements, or variations thereof. Line 130 could be a direct link or may include intermediate networks, systems, or devices. Line 130 could also include only structural support, while each of sensor nodes 110-112 communicate with control node 120 over a wireless link, such as wireless Fidelity (WiFi), Bluetooth, Radio Frequency Identification (RFID), infrared (IR), cellular communication, or some other wireless communication format, including combinations, improvements, or variations thereof.

In operation, sensor nodes 110-112 hang from line 130 at different depths, as suspended from control node 120, and are positioned in tank 101 to measure a fluid level within tank 101. FIG. 1A shows tank 101 at a low level of fullness, as indicated by the low fluid level. FIG. 1B shows tank 101 at a high level of fullness, as indicated by the high fluid level. In FIG. 1A, the fluid level is below the hanging level of the last and lowest sensor node 112. As the fluid level rises, such as when filling tank 101 as shown in FIG. 1B, sensor nodes will float on the surface of the fluid in tank 101 when the level reaches or exceeds the hanging depth of the respective sensor node. When tank 101 has been filled to a desired fluid level, the filling process can be indicated to stop, or the tank could be indicated as being full. A similar process could be employed for emptying tank 101, or maintaining a predetermined fluid level in tank 101. It should be noted that sensor nodes 110-112 are free to float on the surface of the fluid in tank 101, without structural support forcing sensor nodes 110-112 to remain submerged at a predetermined depth when the fluid level reaches or exceeds the hanging depth of the associated sensor node. Control node 120 can monitor sensor nodes 110-112 and indicate when a desired level has been reached. In some examples, each of sensor nodes 110-112 will tip over, or rotate, when floating on the top surface of the fluid in tank 101. This tipping or rotation of a sensor node could activate a sensor in the associated sensor node, such as a mercury switch, magnetic sensor, or accelerometer. The tipping could then be reported to control node 120, which would monitor each of sensor nodes 110-112. Although three sensor nodes 110-112 have been shown in FIGS. 1-2, it should be understood that a different number could be employed.

FIGS. 2A and 2B are system diagrams illustrating tank fullness monitoring system 100, as described above for FIGS. 1A and 1B, although system 100 could use other configurations than described above. In FIGS. 2A and 2B, tank 101 includes two liquids, oil and water. In these examples, the oil is less dense than the water, and the oil does not dissolve in the water, thus the two liquids remain generally separated and form two layers of liquid, with the oil on top of the water. FIG. 2A shows tank 101 at a high level of water fullness, as indicated by the high water level. FIG. 2B shows tank 101 at a low level of water fullness, as indicated by the low water level. In the examples shown in both FIGS. 2A and 2B, the amount of oil is generally unchanged.

In operation, sensor nodes 110-112 hang from line 130 at different depths, as suspended from control node 120, and are positioned in tank 101 to measure two different fluid levels within tank 101. FIG. 2A shows the water level as being high, above the hanging level of the last two sensor nodes 111-112. The oil layer, as shown floating on top of the water layer, is above the hanging level of the first sensor node 110. In FIGS. 2A-2B, the buoyancy of sensor nodes 111-112 is configured to allow sensor nodes 111-112 to float on water but sink in the oil. For example, the specific gravity or relative density of each sensor nodes 111-112 could be configured to be less than water but greater than the oil. Also in FIGS. 2A-2B, the buoyancy of sensor node 110 is configured to allow sensor node 110 to float on the oil. For example, the specific gravity or relative density of sensor node 110 could be configured to be less than the oil. It should be noted that sensor nodes 110-112 are free to float at a fluid interface in tank 101, such as the oil-water interface for sensor nodes 111-112 and the oil-air interface for sensor node 110, without structural support forcing sensor nodes 110-112 to remain submerged at a predetermined depth. Control node 120 can monitor sensor nodes 110-112 and indicate when a desired level has been reached. In some examples, each of sensor nodes 110-112 will tip over, or rotate, when floating at the appropriate fluid interface in tank 101. This tipping or rotation of a sensor node could activate a sensor in the associated sensor node, such as a mercury switch, magnetic sensor, or accelerometer. The tipping could then be reported to control node 120, which would monitor each of sensor nodes 110-112.

In the example shown in FIGS. 2A-2B, the water is desired to be removed from tank 101, while leaving the oil behind. As the water is removed from tank 101, the total fluid level falls, such as when evacuating tank 101 as shown in FIG. 2B. As the oil level in tank 101—as affected by the underlying water depth—decreases in FIG. 2B, sensor node 110 will cease floating on the top surface of the oil, and instead hang from line 130. Sensor node 110 could also tip or rotate back into a default configuration, and indicate a non-floating state to control node 120. Also, sensor node 111 is shown to be above the water level, and thus hanging from line 130. It should be noted that sensor node 111 is configured to have a relative density greater than oil, so it will sink in the oil and be suspended from line 130 when the water level is below the hanging level of sensor 111. Furthermore, in FIG. 2B, the water level is still above the hanging level of sensor node 112, and sensor node floats at the water-oil interface. Thus, the water level of tank 101 as shown in FIG. 2B has been reduced without affecting the amount of oil remaining in tank 101. In a similar manner, all of the water could be removed from tank 101 without removing any oil, or a significant portion thereof. A similar process could be employed for filling tank 101 with multiple fluids, or maintaining a predetermined fluid level for multiple fluids in tank 101. It should be noted that sensor nodes 110-112 are free to float on the surface of the fluid in tank 101, without structural support forcing sensor nodes 110-112 to remain at a predetermined depth. Only when not floating at a fluid interface—whether due to no liquid present, or due to selective buoyancy, will any of sensor nodes 110-112 hang from line 130. As in FIGS. 1A-1B, control node 120 can monitor sensor nodes 110-112 and indicate when a desired level has been reached. A greater number of sensor nodes could be employed to achieve a finer granularity measurement of the fluid levels in tank 101.

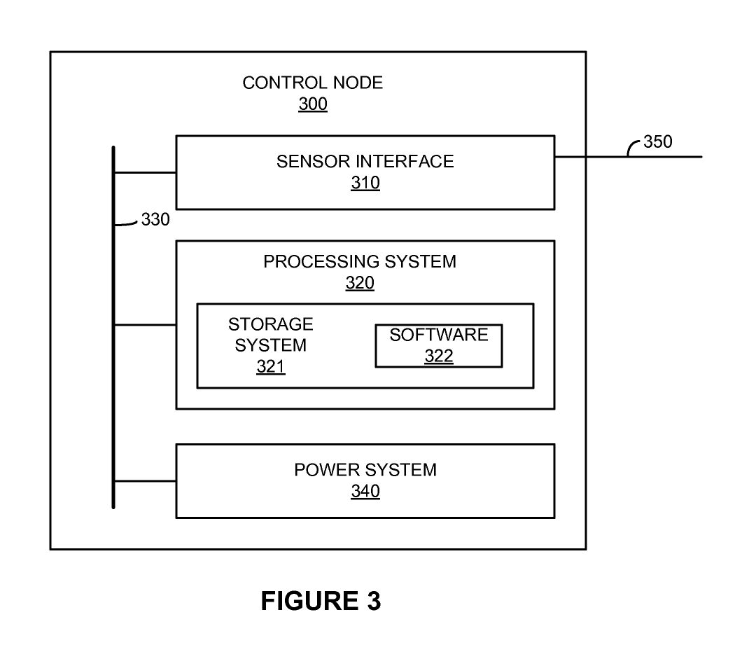

FIG. 3 is a block diagram illustrating control node 300, as an example of control node 120 found in FIGS. 1-2, although control node 120 could use other configurations. Control node 300 includes sensor interface 310, processing system 320, and power system 340. Sensor interface 310, processing system 320, and power system 340 communicate over bus 330. Control node 300 may be distributed among multiple devices that together form elements 310, 320-322, 330, 340, and 350.

Sensor interface 310 comprises transceiver equipment for communicating with and controlling sensor nodes, such as sensor nodes 110-112. Sensor interface 310 exchanges communications over link 350. Link 350 could use various protocols or communication formats as described herein for line 130, including combinations, variations, or improvements thereof.

Processing system 320 includes storage system 331. Processing system 330 retrieves and executes software 322 from storage system 331. In some examples, processing system 320 is located within the same equipment in which sensor interface 310 or power system 340 is located. In further examples, processing system 320 comprises specialized circuitry, and software 322 or storage system 321 could be included in the specialized circuitry to operate processing system 320 as described herein. Storage system 321 could include a non-transient computer-readable medium such as a disk, tape, integrated circuit, server, or some other memory device, and also may be distributed among multiple memory devices. Software 322 may include an operating system, logs, utilities, drivers, networking software, and other software typically loaded onto a computer system. Software 322 could contain an application program, firmware, or some other form of computer-readable processing instructions. When executed by processing system 320, software 322 directs processing system 320 to operate as described herein, such as monitor sensor nodes over link 350, or control the operation of sensor nodes.

Bus 330 comprises a physical, logical, or virtual communication and power link, capable of communicating data, control signals, power, and other communications. In some examples, bus 330 is encapsulated within the elements of sensor interface 310, processing system 320, or power system 340, and may include a software or logical link. In other examples, bus 330 uses various communication media, such as air, space, metal, optical fiber, or some other signal propagation path, including combinations thereof. Bus 330 could be a direct link or might include various equipment, intermediate components, systems, and networks.

Power system 340 includes circuitry and a power source to provide power to the elements of control node 300. The power source could include a battery, solar cell, spring, flywheel, capacitor, thermoelectric generator, nuclear power source, chemical power source, dynamo, or other power source. In some examples, power system 240 receives power from an external source, and processes the power for use by control node 300 over bus 330 and for use by sensor nodes over link 350. Power system 340 also includes circuitry to condition, monitor, and distribute electrical power to the elements of control node 300.

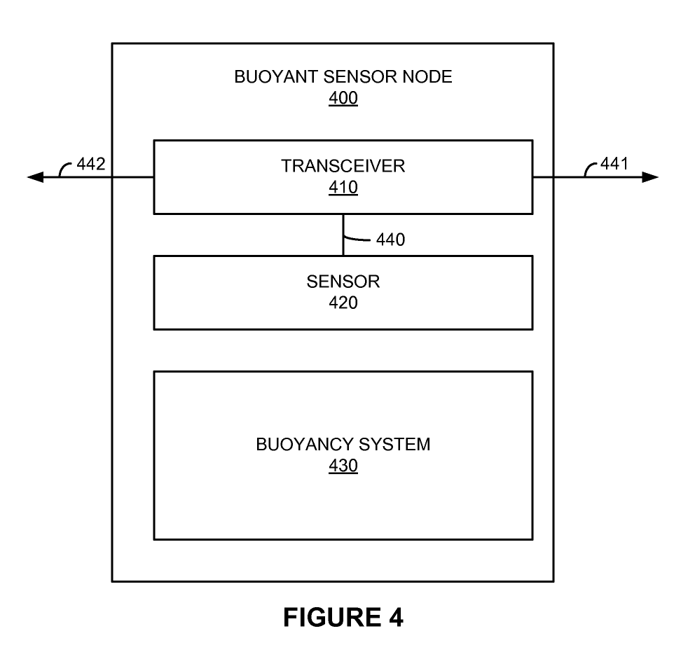

FIG. 4 is a block diagram illustrating buoyant sensor node 400, as an example of sensor nodes 110-112 found in FIGS. 1-2, although sensor nodes 110-112 could use other configurations. Sensor node 400 includes transceiver 410, sensor 420, and buoyancy system 430. Transceiver 410 and sensor 420 communicate over link 440. Sensor node 400 may be distributed among multiple devices that together form elements 410, 420, 430, and 440-442.

Transceiver 410 comprises a communication interface for communicating with a control node and other sensor nodes, such as control node 120 or sensor nodes 110-112. Transceiver 410 could include transceiver equipment and antenna elements for exchanging sensor information, data, or other information, with a control node, omitted for clarity, over link 441. Transceiver 410 also provides feed-through communication link 442 for daisy-chaining another sensor node to sensor node 400, such as shown in FIGS. 1-2 with a serial chain of 3 sensor nodes 110-112, although other configurations could be used. In some examples, transceiver 410 conditions, amplifies, or repeats communications exchanged over link 441 for use over link 442. In other examples, transceiver 410 does not logically interface with link 442, and pass-through electrical connections, such as wires or traces, are employed. Transceiver 410 could use various protocols or communication formats as described herein for line 130, including combinations, variations, or improvements thereof.

Sensor 420 comprises a sensor or sensors for monitoring a fluid level. The sensor could comprise, for example, level sensors, mercury switches, thermometers, thermocouples, thermopiles, infrared (IR) emitters/detectors, microphones, ultrasonic emitters/detectors, accelerometers, strain gauges, flow gauges, chemical sensors, micro-electromechanical system (MEMS) sensors, electrical sensors, among other sensing equipment and circuitry. Sensor 420 could include sensor circuitry, amplifiers, analog-to-digital converters, microcontrollers, among other circuitry. In some examples, sensor 420 is configured to indicate when sensor node 400 changes in a physical configuration, such as when tipped over or when floating at a fluid interface.

Buoyancy system 430 establishes a buoyancy of sensor node 400 in a fluid environment. Buoyancy system 430 could include an air space, gas bladder, foam, wood, polymer, or other buoyant material or space. In some examples, buoyancy system 430 is configured to have a certain specific gravity or relative density, to allow sensor node 400 to have different buoyancy characteristics in different fluids, such as float on water, but sink in oil. Other buoyancy characteristics could be employed for different fluids. In further examples, buoyancy system 430 is configured to rotate or tip sensor node 400 when at a fluid interface or when floating. A shape, orientation, or location of buoyancy system 430 could be employed to rotate sensor node 400. Buoyancy system 430 could comprise the enclosure or case of sensor node 400, or be an element within an enclosure of sensor node 400, among other configurations.

Link 440 comprises a physical, logical, or virtual communication and power link, capable of communicating data, control signals, power, and other communications. In some examples, link 440 is encapsulated within the elements of transceiver 410 or sensor 420, and may include a software or logical link. In other examples, link 440 uses various communication media, such as air, space, metal, optical fiber, or some other signal propagation path, including combinations thereof. Link 440 could be a direct link or might include various equipment, intermediate components, systems, and networks.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A tank fullness monitoring system, comprising:
a plurality of buoyant sensor nodes coupled in series along a line, wherein the buoyant sensor nodes are configured to hang in series along the line, and wherein each of the buoyant sensor nodes is configured to indicate when floating at a fluid interface;
a control node attached to the tank and coupled to a first one of the buoyant sensor nodes, and configured to monitor the buoyant sensor nodes.

2. The tank fullness monitoring system of claim 1, wherein the fluid interface comprises an interface between a gas and a liquid, and wherein each of the buoyant sensor nodes is configured to indicate when floating on a surface of the liquid.

3. The tank fullness monitoring system of claim 1, wherein at least a last one of the buoyant sensor nodes along the line has a relative density less than a first liquid but greater than a second liquid.

4. The tank fullness monitoring system of claim 3, wherein the first liquid comprises water and the second liquid comprises oil.

5. The tank fullness monitoring system of claim 1, wherein the line comprises an electrical signaling portion and a tension support portion.

6. The tank fullness monitoring system of claim 1, wherein each of the plurality of buoyant sensor nodes comprises a buoyancy portion and a sensor portion.

7. The tank fullness monitoring system of claim 1, wherein the line comprises a flexible cable.

8. The tank fullness monitoring system of claim 1, wherein the line comprises a signal link, wherein each of the buoyant sensor nodes is configured to indicate when floating at a fluid interface by signaling along the signal link, and wherein the control node is configured to monitor the signal link to monitor the buoyant sensor nodes.

9. The tank fullness monitoring system of claim 1, wherein each of the buoyant sensor nodes is configured to wirelessly indicate when floating at a fluid interface, and wherein the control node is configured to wirelessly monitor the buoyant sensor nodes.

10. The tank fullness monitoring system of claim 1, wherein each of the buoyant sensor nodes is configured to communicate over the line with the control node.

11. A method of operating a tank fullness monitoring system, the method comprising:
in each of a plurality of buoyant sensor nodes coupled in series along a line and configured to hang in series along the line, indicating when floating at a fluid interface;
in a control node attached to the tank and coupled to a first one of the buoyant sensor nodes, monitoring the buoyant sensor nodes.

12. The method of claim 11, wherein the fluid interface comprises an interface between a gas and a liquid, and wherein indicating when floating at the fluid interface comprises, in each of the buoyant sensor nodes, indicating when floating on a surface of the liquid.

13. The method of claim 11, wherein at least a last one of the buoyant sensor nodes along the line has a relative density less than a first liquid but greater than a second liquid.

14. The method of claim 13, wherein the first liquid comprises water and the second liquid comprises oil.

15. The method of claim 11, wherein the line comprises an electrical signaling portion and a tension support portion.

16. The method of claim 11, wherein each of the plurality of buoyant sensor nodes comprises a buoyancy portion and a sensor portion.

17. The method of claim 11, wherein the line comprises a flexible cable.

18. The method of claim 11, wherein the line comprises a signal link, wherein indicating when floating at the fluid interface comprises, in each of the buoyant sensor nodes, indicating when floating at a fluid interface by signaling along the signal link, and wherein monitoring the buoyant sensor nodes comprises, in the control node, monitoring the signal link.

19. The method of claim 11, wherein indicating when floating at the fluid interface comprises, in each of the buoyant sensor nodes, wirelessly indicating when floating at a fluid interface, and wherein monitoring the buoyant sensor nodes comprises, in the control node, wirelessly monitoring the buoyant sensor nodes.

20. The method of claim 11, further comprising:
in each of the buoyant sensor nodes, communicating over the line with the control node.
